(19) United States
(12) Patent Application Publication
(10) Pub. No.: US 2009/0029279 A1
(43) Pub. Date: Jan. 29, 2009

(54) TONER, TWO-COMPONENT DEVELOPER, AND IMAGE FORMING APPARATUS USING THE TONER AND THE TWO-COMPONENT DEVELOPER

(76) Inventors: Takamichi Mori, Yamatokoriyama-shi (JP); Takeshi Katoh, Kizugawa-shi (JP); Takeshi Tsukiyama, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/173,340

(22) Filed: Jul. 15, 2008

(30) Foreign Application Priority Data
Jul. 23, 2007 (JP) P2007-191334

(51) Int. Cl. G03G 9/087; G03G 9/083; G03G 15/08

(52) U.S. Cl. 430/109.1; 430/111.41; 399/252

(57) ABSTRACT

A toner is provided which is capable of preventing a decrease in a toner charge amount and thus preventing fog and a decrease in image density even in a case where images of low coverage are continuously printed or where a printing operation restarts immediately after long suspension of operation in an image forming apparatus. The toner contains coloring resin particles formed of a boron compound, a hinder resin, and a colorant, and an external additive of which a primary particle is adjusted to have a size of 16 nm or more and 30 nm or less and of which a volume resistivity is adjusted to 1×10¹² Ω·cm or more and 5×10¹⁵ Ω·cm or less.

### CROSS-REFERENCE TO RELATED APPLICATION

This application claims priority to Japanese Patent Application No. 2007-191334, which was filed on Jul. 23, 2007, the contents of which are incorporated herein by reference in its entirety.

### BACKGROUND OF THE INVENTION

1. Field of the Invention

The present invention relates to a toner, a two-component developer, and an image forming apparatus using the same, for the use in visualizing a latent image such as an electrostatic latent image in an image forming method represented by electrophotography.

2. Description of the Related Art

In forming an image on a recording medium in an image forming apparatus using an electrophotographic system, the image is formed on the recording medium as follows. Firstly, in a charging section, a photoreceptor driven to rotate has its surface uniformly charged. Subsequently, in an exposure section, the surface of the photoreceptor is irradiated with laser light so that an electrostatic latent image is formed on the surface of the photoreceptor. Next, in a developing section, a developer containing charged fine particles called a toner is supplied to the electrostatic latent image formed on the surface of the photoreceptor so that a visualized image, i.e., a toner image is formed on the surface of the photoreceptor. And then, in a transferring section, the toner image is transferred onto the recording medium. After that, in a fixing section, the toner image transferred onto the recording medium is fixed thereto, with the result that an image is formed on the recording medium. Further, in a cleaning section, a transfer-residual toner remaining on the surface of the photoreceptor is removed and moreover, in an electricity removing section, residual charges on the surface of the photoreceptor are removed, thereby preparing for next image formation.

There are known two kinds of developer for developing the electrostatic latent image formed on the surface of the photoreceptor. The developer includes a one-component developer formed of a toner only, and a two-component developer formed of a toner and magnetic particles called a carrier. The one-component developer is advantageous in that the developing section has a simple structure with no need of an agitating mechanism, etc. for mixing the toner and the carrier evenly since the one-component developer contains no carrier. However, the one-component developer has disadvantages such that stabilization of a charge amount of the toner is not easy. The two-component developer is disadvantageous in that the developing section has a complicated structure with a need for an agitating mechanism, etc. for mixing the toner and the carrier evenly. However, the two-component developer is excellent in adaptability to a high-speed image forming apparatus forming images at high speed and a color image forming apparatus forming color images since an amount of charges given to the toner is stable.

As to the high-speed image forming apparatus and the color image forming apparatus, there is a strong users' demand for downsizing of the apparatus and therefore exists a demand for downsizing also of a developing device which stores a developer. In order to use a two-component developer in a downsized developing device, it is required that a toner contained in the two-component developer should have a property of attaining an optimum toner charge amount for development in a short time through contact with the carrier contained inside a developer tank (which property is called a high-rate charge rising property) as well as a property of having the toner charge amount less easily changing inside the developer tank (which property is called charge stability). With the purpose of achieving the high-rate change rising property and the charge stability, a toner containing a charge control agent is used. Japanese Examined Patent Publication JP-B2 7-13765 (1995) discloses a toner containing as a charge control agent a boron compound represented by the following structural formula (2), for example. Such a boron compound represented by the following structural formula (2) is highly negative electric and therefore results in a toner excellent in the charge stability, allowing for images which are stable in density and free from fogs even in a case of continuously printing images of high coverage. Moreover, the boron compound is a colorless substance which is suitably used as a charge control agent for a color toner.

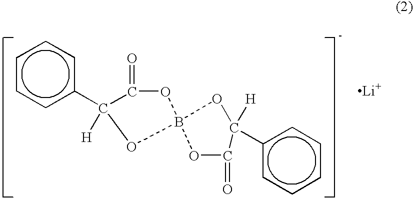

In the case where the toner disclosed by JP-B2 7-13765 is used as a toner of two-component developer, the toner generally contains an external additive for providing the toner with fluidity. FIGS. 5A and 5B are sectional views each showing constitution of the two-component developer having a toner 110 and a carrier 114 according to the related art. The toner 110 contains a boron compound 112, coloring resin particles 111 formed of a hinder resin and a colorant, and an external additive 113. The toner 110 has the external additive 113 externally added to surfaces of the coloring resin particles 111 as shown in FIG. 5A. The externally additive agent 113 has not only an effect of enhancing a conveyance property of the toner 110 by giving the toner 110 the fluidity, but also an effect of preventing the boron compound 112 contained in the coloring resin particles 111 from directly contacting the carrier 114 which effect is called a spacer effect. Owing to the spacer effect, negative charges held by the boron compound 12 can be prevented from leaking to the carrier 114 so that the toner 110 can maintain its charge stability.

In forming images in the image forming apparatus using the two-component developer containing the toner 110, the external additive 113 may be, however, buried in the coloring resin particles 111 as shown in FIG. 5B in the case where images of low coverage are continuously printed that consume a small amount of the toner 110 and thus cause an exchange of the toner 110 in small amount, or where when the image forming apparatus has not operated for a long time. This is because, in the above cases, the toner 110 is agitated inside the developer tank for a longer time. In the case where the external additive 113 is buried in the coloring resin particles 111 as above, the boron compound 112 contained in the coloring resin particles 111 directly contact the carrier 114, thus causing the negative charges held by the boron compound 112 to more easily leak to the carrier 114. As a result, in the case where images of low coverage are continuously printed or where a printing operation restarts immediately after long suspension of operation in the image forming apparatus, the toner has charges extremely decreasing and causes fog, decrease in image density, or the like trouble.

### SUMMARY OF THE INVENTION

An object of the invention is to provide a toner, a two-component developer, and an image forming apparatus using the same, being capable of preventing decrease in toner charge amount and thus preventing fog and decrease in image density, even in a case where images of low coverage are continuously printed or where a printing operation restarts immediately after long suspension of operation in the image forming apparatus.

The invention provides a toner comprising:

coloring resin particles formed of at least a boron compound, a binder resin and a colorant,

the boron compound being represented by the following general formula (1):

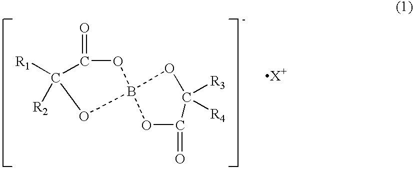

(where R₁ and R₄ each represents a hydrogen atom, an alkyl group, or a substituted or non-substituted aromatic ring (including a condensed ring), R₂ and R₃ each represents a substituted or non-substituted aromatic ring (including a condensed ring), and X⁺ represents a cation); and

an external additive externally added to surfaces of the coloring resin particles, the external additive being adjusted to have a primary particle size of 16 nm or more and 30 nm or less and a volume resistivity of 1×10¹² Ω·cm or more and 5×10¹⁵ Ω·cm, and

a surface coverage of the coloring resin particles with the external additive being 25% or more and 50% or less.

According to the invention, a toner comprises coloring resin particles formed of a boron compound having a specific structure, a binder resin and a colorant; and an external additive being externally added to surfaces of the coloring resin particles. Since primary particles of the external additive have a size of 16 nm or more and 30 nm or less, the external additive can be prevented from being completely buried in the coloring resin particles even in the case where images of low coverage are continuously printed or where the image forming apparatus has not operated for a long time. Moreover, the toner is adjusted so that a volume resistivity of the external additive agent is 1×10¹² in cm or more and 5×10¹⁵ Ω·cm or less and therefore, charges held by the toner can be prevented from leaking through the external additive. Hence, the toner is capable of preventing its charges from decreasing and thus, preventing fog and decrease in image density. Furthermore, the toner is adjusted so that surface coverage of the coloring resin particles with the external additive is 25% or more and 50% or less. The toner is therefore provided with sufficient fluidity and moreover, a charge amount of the toner can be sufficiently prevented from decreasing.

Further, in the invention, it is preferable that the external additive is formed of fine silica particles having a hydrophobized surface.

According to the invention, the external additive is formed of fine silica particles having a hydrophobized surface and therefore, the external additive can be prevented from absorbing moisture, with the result that the toner can be prevented from having charges fluctuating in amount even under humid environment.

Further, in the invention, it is preferable that the coloring resin particles have a volume average particle size of 5 μm or more and 7 μm or less and BET specific surface area of 1.5 m²/g or more and 1.9 m²/g or less.

According to the invention, the coloring resin particles are adjusted to have a volume average particle size of 5 μm or more and 7 μm or less and BET specific surface area of 1.5 m²/g or more and 1.9 m²/g or less. The coloring resin particles therefore have surfaces with reduced irregularities, with the result that the external additive can be prevented from entering into such irregularities and thus uniformly attached to the surfaces of the coloring resin particles. As a result, the toner is provided with sufficient fluidity and sufficiently exhibits the spacer effect inherent to the external additive (which effect indicates a leak-proof effect of charges held by the toner), thus allowing for prevention of fog generation as well as prevention of toner scattering.

The invention provides a two-component developer containing the toner and a magnetic carrier having a volume resistivity of 1×10⁹ Ω·cm or more and 2×10¹¹ Ω·cm or less.

According to the invention, the two-component developer contains the above toner and a magnetic carrier. Since the external additive of the above toner is prevented from being completely buried in the coloring resin particles even in the case where image of low coverage are continuously printed or where the image forming apparatus has not operated for a long time, the boron compound contained in the coloring resin particles is prevented from directly contacting the carrier so that the negative charges held by the boron compound can be prevented from leaking to the carrier. Consequently, even in the case where images of low coverage are continuously printed or where a printing operation restarts immediately after long suspension of operation in the image forming apparatus, the toner can be prevented from having charges extremely decreasing and from causing fog, a decrease in image density, or the like trouble.

Furthermore, the carrier is adjusted to have a volume resistivity of 1×10⁹ Ω·cm or more and 2×10¹¹ Ω·cm or less. By adjusting the volume resistivity of the carrier to 1×10⁹ Ω·cm or more, charges on a photoreceptor can be prevented from leaking to the carrier in developing an electrostatic latent image carried by the photoreceptor, and an image thus obtained can be prevented from having brush lines. Moreover, by adjusting the volume resistivity of the carrier to 2×10¹¹ Ω·cm or less, the toner can be prevented from having a charge amount extremely rising through contact with the carrier, so that reduction of image density of an image obtained can be prevented.

Further, in the invention, it is preferable that the carrier is composed of a core particle and a coating layer with which the core particle is coated and the coating layer has a thickness of 0.5 μm or more and 5 μm or less.

According to the invention, the carrier is composed of a core particle and a coating layer with which the core particle is coated, and a thickness of the coating layer is adjusted to 0.5 μm or more and 5 μm or less. By adjusting the thickness of the coating layer to 0.5 μm or more, charges in a surface of a photoreceptor can be prevented from leaking to the carrier, and an image thus obtained can be prevented from having brush lines. By adjusting the thickness of the coating layer to 5 μm or less, counter charges remaining in the carrier after toner development can be eliminated swiftly.

Further, in the invention, it is preferable that the coating layer of the carrier contains a conductive agent, and the conductive agent is carbon black having an oil absorption of 90 mL/100 g or more and 170 ml/100 g or less.

According to the invention, the coating layer of the carrier contains a conductive agent, and the conductive agent is carbon black having an oil absorption of 90 ml/100 g or more and 170 ml/100 g or less. This makes it possible to easily form the coating layer where the conductive agent is evenly dispersed so that the charges in the surface of the photoreceptor can be further prevented from moving to the carrier.

The invention provides an image forming apparatus comprising: a photoreceptor for bearing an electrostatic latent image; a charging section for charging a surface of the photoreceptor; an exposure section for forming the electrostatic latent image on the surface of the photoreceptor; a developing section for supplying a developer to the electrostatic latent image formed on the surface of the photoreceptor to form a visualized image; a transferring section for transferring the visualized image to a recording medium; a cleaning section for removing the developer remaining on the surface of the photoreceptor; and a fixing section for fixing the visualized image transferred to the recording medium, the developer being the two-component developer.

According to the invention, the developer used in the image forming apparatus to form mages is the above two-component developer. Since images are formed by use of the two-component developer having the toner with charges prevented from leaking to the carrier, the toner can be prevented from having charges extremely decreasing and from causing fog, a decrease in image density, or the like trouble, even in the case where images of low coverage are continuously printed or where a printing operation restarts immediately after long suspension of operation in the image forming apparatus.

### BRIEF DESCRIPTION OF THE DRAWINGS

Other and further objects, features, and advantages of the invention will be more explicit from the following detailed description taken with reference to the drawings wherein:

FIGS. 1A and 1B are sectional views each showing constitution of a toner and a carrier according to one embodiment of the invention;

FIG. 2 is a view showing a configuration of an image forming apparatus according to one embodiment of the invention;

FIG. 3 is a sectional view showing a configuration of a developing section;

FIG. 4 is a view showing a magnetic intensity distribution of respective poles of a magnet roller provided in a developing roller;

FIGS. 5A and 5E are sectional views each showing constitution of a toner and a carrier according to a related art.

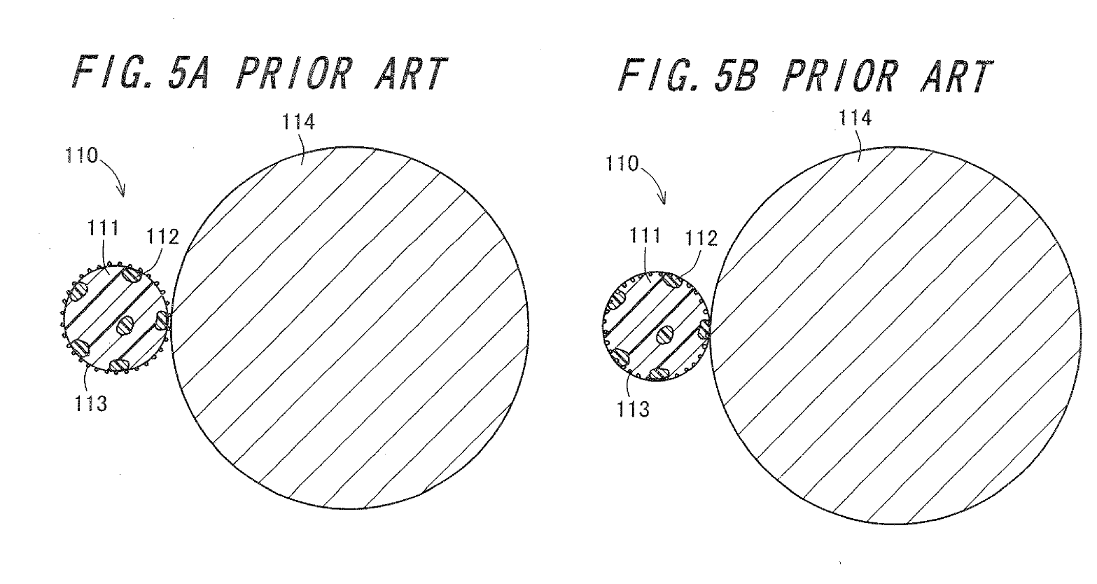

### DETAILED DESCRIPTION

Now referring to the drawings, preferred embodiments of the invention are described below.

A toner of the invention contains coloring resin particles and an external additive of which a primary particle size and a volume resistivity are adjusted to fall in a predetermined range.

[Coloring Resin Particles]

The coloring resin particles are formed of at least a boron compound, a binder resin, and a colorant.

(Boron Compound)

The boron compound is represented by the following general formula (1):

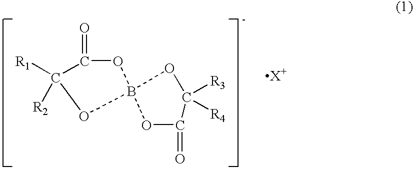

(where R₁ and R₄ each represents a hydrogen atom, an alkyl group, or a substituted or non-substituted aromatic ring (including a condensed ring), R₂ and R₃ each represents a substituted or non-substituted aromatic ring (including a condensed ring), and X⁺ represents a cation). The boron compound is highly negative electric and exhibits charge stability. Accordingly, by adding the boron compound to the toner, the toner can be provided with high-rate charge rising property and charge stability.

The compound expressed by the general formula (1) will be explained in detail. The alkyl groups represented by R₁ and R₄ include a methyl group, an ethyl group, an n-butyl group, an iso-amyl group, an n-dodecyl group, an n-octadecyl group, and a cyclohexyl group. The aromatic rings represented by R₁, R₂, R₃ and R₄ include a benzene ring and a naphthalene ring. The substituent includes an alkyl group, an alkoxy group, a halogen atom, an aryl group, an aralkyl group, a nitro group, and a cyan group. The cation includes various an inorganic cation and an organic cation. The inorganic cation includes a hydrogen ion and a metal ion, and a monovalent and divalent metal ion includes Li⁺, Na⁺, K⁺, Mg²⁺, Ca²⁺, and Zn²⁺. The organic cation includes an ammonium ion, an iminium ion, or a sulfonium ion. The following table 1 shows specific examples of such a boron compound.

TABLE 1

| Compound | |
|---|---|
| No. | Structural Formula |
| B1 | 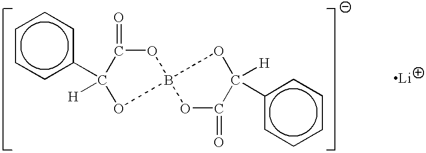 |
| B2 | 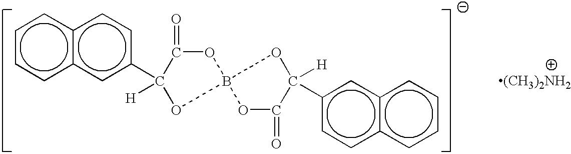 |
| B3 | 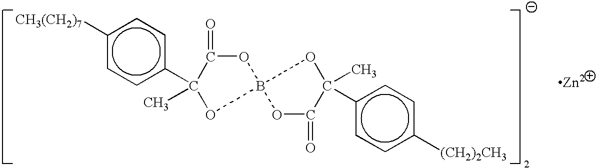 |
| B4 | 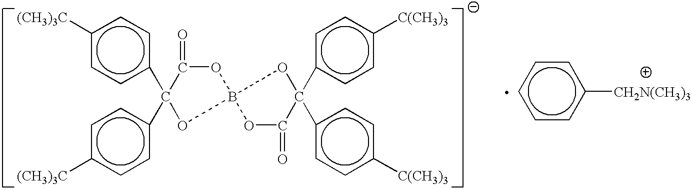 |
| B5 | 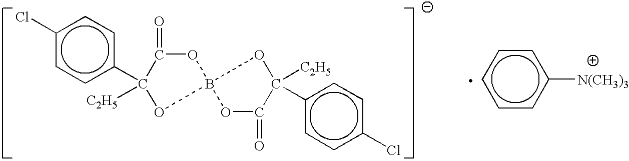 |

An amount of the boron compound to be added is preferably 0.5 part by weight or more and 3 parts by weight or less and more preferably 1 part by weight or more and 2 parts by weight or less based on 100 parts by weight of the later-described binder resin.

(Binder Resin)

For the binder resin, resin customarily used as a binder resin for toner can be used including, for example: polyester resin; styrene-acrylic resin such as polystyrene-acrylic ester copolymer; styrene resin such as polystyrene; (meth)acrylic resin; vinyl chloride resin; phenol resin; epoxy resin; polyurethane resin; and polyvinyl butyral resin. Among the resin, linear or non-linear polyester resin is preferred. Polyester resin is excellent for achieving a balance among mechanical strength (less easily generating fine particles due to abrasion, etc.), a fixing property (being less easily peeled off from paper after the fixing process), and an anti-offset property.

Polyester resin can be obtained by polymerizing monomer compounds formed of divalent or higher-valent polyalcohol and polybasic acid, and according to need, trivalent or higher-valent polyalcohol or polybasic acid. The divalent alcohol used for polymerization of polyester resin includes, for example: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, and 1,6-hexanediol; and bisphenol A alkylene oxide adduct such as bisphenol A, hydrogenated bisphenol A, polyoxyethylenated bisphenol A, and polyoxypropylenated bisphenol A.

The trivalent or higher-valent polyalcohol includes, for example: sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

The divalent polybasic acid includes, for example, maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, and anhydrides of these acids, lower alkyl ester, or alkenyl succinic acids or alkyl succinic acids such as n-dodecenyl succinic acid or n-dodecyl succinic acid.

The trivalent or higher-valent polybasic acid includes, for example, 1,2,4-benzenetricarboxylic acid, 1,2,5-benzenetricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxy-2-methyl-2-methylenecarboxypropane, tetra(methylenecarboxyl)methane, 1,2,7,8-octanetetracarboxylic acid, and anhydrides thereof.

(Colorant)

For the colorant, pigments and dye customarily used as a colorant for toner can be used. A colorant for black toner includes carbon black and magnetite. A colorant for yellow toner includes: acetoacetic arylamide monoazo yellow pigments such as C.I. pigment yellow 1, C.I. pigment yellow 3, C.I. pigment yellow 74, C.I. pigment yellow 97, and C.I. pigment yellow 98; acetoacetic arylamide disazo yellow pigments such as C.I. pigment yellow 12, C.I. pigment yellow 13, C.I. pigment yellow 14, and C.I. pigment yellow 17; condensed monoazo yellow pigments such as C.I. pigment yellow 93 and C.I. pigment yellow 155; other yellow pigments such as C.I. pigment yellow 180, C.I. pigment yellow 150, and C.I. pigment yellow 185; and yellow dye such as C.I. solvent yellow 19, C.I. solvent yellow 77, C.I. solvent yellow 79, and C.I. disperse yellow 164.

A colorant for magenta toner includes, for example: red or violet pigment such as C.I. pigment red 48, C.I. pigment red 49:1, C.I. pigment red 53:1, C.I. pigment red 57, C.I. pigment red 57:1, C.I. pigment red 81, C.I. pigment red 122, C.I. pigment red 5, C.I. pigment red 146, C.I. pigment red 184, C.I. pigment red 238, and C.I. pigment violet 19; and red dye such as C.I. solvent red 49, C.I. solvent red 52, C.I. solvent red 58, and C.I. solvent red 8. A colorant for cyan toner includes, for example: blue dye and pigments of copper phthalocyanine and derivatives thereof such as C.I. pigment blue 15:3 and C.I. pigment blue 15:4; and green pigments such as C.I. pigment green 7 and C.I. pigment green 36 (phthalocyanine green). An amount of the colorant to be added is preferably 1 part by weight or more and 15 parts by weight or less and more preferably 2 parts by weight or more and 10 parts by weight or less based on 100 parts by weight of the binder resin.

The coloring resin particles are formed of at least the above boron compound, a binder resin and a colorant. A volume average particle size of the coloring resin particles is preferably 3 μm or more and 15 μm or less and more preferably 5 μm or more and 7 μm or less as being excellent in its dot reproducibility. Note that the volume average particle size was measured by use of Coulter Multisizer II (manufactured by Beckman Coulter, inc.) with an aperture of 100 μm. Further, the coloring resin particles preferably have BET specific surface area of 1.5 m²/g or more and 1.9 m²/g or less. Coloring resin particles with BET specific surface area exceeding 1.9 m²/g will have more irregular surfaces whose concave parts catch the later-described external additive to be externally added to the toner surface, thus causing a difficulty in letting the external additive evenly attached to the toner surface. As a result, the toner will fail to be provided with sufficient skid effect (of enhancing fluidity of the toner) and spacer effect (of preventing charges from leaking) inherent to the external additive, thus being more liable to cause fog and to scatter. Coloring resin particles with BET specific surface area less than 1.5 m²/g tend to have too smooth surfaces and therefore cause a cleaning failure which easily generates fog.

The coloring resin particles having BET specific surface area within a desired range can be obtained by rounding particles into corner-free shape. A method of such rounding is, for example, a process of rotating a cylindrical pipe containing coloring resin particles at high speed, and a suffusion system of instantaneously melting a toner in hot air. Note that the BET specific surface area was measured in a BET specific surface area analyzer: Gemini 2360 (manufactured by Shimadzu Corporation) through a three-point analysis process.

The coloring resin particles can be manufactured by a known method such as a kneading/pulverizing method or a polymerization method, in manufacturing the coloring resin particles, an additive such as a release agent may be added other than the above boron compound, a binder resin, a colorant, and a conductive agent. When the release agent is added, the toner has an enhanced releasing property with respect to a fixing roller or a fixing belt so that high-temperature/low-temperature offset can be prevented in the fixing process. An amount of the release agent to be added is not particularly limited and 1 part by weight or more and 5 parts by weight or less based on 100 parts by weight of the binder resin. Examples of the release agent include: synthetic wax such as polypropylene and polyethylene; petroleum wax such as paraffin wax and derivatives thereof, and microcrystalline wax and derivatives thereof; modified wax of the petroleum wax; and vegetable wax such as carnauba wax, rice wax, and candelilla wax.

In the case of manufacturing the coloring resin particles by the kneading/pulverizing method, the boron compound, the binder resin, the colorant, the conductive agent, the release agent, and other additives are firstly mixed with each other in a mixer selected from HENSCHELMIXER, SUPERMIXER, MECHANOMILL, and a Q-type mixer. Next, a mixture thus obtained is molten and kneaded at a temperature around 70° C. or more and 180° C. or less by a kneading machine selected from a twin-screw kneader, a single-screw kneader, etc. A kneaded material thus obtained is then cooled down to be solidified, and a solidified material thus obtained is then pulverized by an air pulverizer such as a jet mill, followed by particle size adjustment such as classification according to need. The coloring resin particles can be thus manufactured.

[External Additive]

The toner of the invention contains an external additive. The external additive is externally added to surfaces of the coloring resin particles and thereby provides a toner with fluidity to enhance a conveyance property of the toner. A primary particle of the external additive have a size of 16 nm or more and 30 nm or less. An external additive with the primary particle size of 16 nm or more can be prevented from being completely buried in the coloring resin particles even in the case where image of low coverage are continuously printed or where the image forming apparatus has not operated for a long time. An external additive with the primary particle size of 30 nm or less can suppress an increase in its amount to be added necessary for coating the coloring resin particles and suppress a decrease in a fixing property of a toner molten to be fixed to a recording medium.

Furthermore, the external additive is adjusted to have a volume resistivity of 1×10¹² Ω·cm or more and 5×10¹⁵ Ω·cm or less. The volume resistivity of the external additive can be adjusted depending on, for example, a kind of a base constituting the external additive. Examples of the base constituting the external additive include inorganic materials such as silica, alumina, and titanium oxide. Further, the above adjustment can also be carried out) by changing a kind or treatment amount of a surface treatment agent for treating a surface of the external additive, which will be hereinafter described in detail.

Since the volume resistivity of the external additive is adjusted to 1×10¹² Ω·cm or more as above, the charges held by the toner can be prevented from leading through the external additive. Accordingly, the toner can suppress a decrease of its charges and thus prevent fog and a decrease of image density in an image obtained. Furthermore, the external additive can be manufactured at relatively low cost since the volume resistivity of the external additive is adjusted to 5×10¹⁵ Ω·cm or less. Note that the volume resistivity of the external additive was measured by the compression method adopting the following procedure. Firstly, the external additive left for 24 hours under environment having a temperature of 20° C. with 65% humidity was sandwiched between two copper plate electrodes and pressed at pressure of 10 kg/cm² until a distance between the copper plate electrodes becomes 8 mm or more and 10 mm or less. A sample was thus prepared. Next, voltage was applied to the sample so as to create field intensity of 500 V/cm, and resistivity was measured when fifteen seconds passed after the application of voltage. The voltage resistivity of the external additive was thus determined.

The external additive is preferably formed of fine silica particles having hydrophobized surfaces. The external additive having its surface thus hydrophobized can be prevented from absorbing moisture, with the result that the toner can be prevented from having charges fluctuating in amount. Moreover, when the surface of the external additive is hydrophobized, the negative charges held by the boron compound contained in the coloring resin particles can be prevented from leaking to the external additive positively charged so that the external additive can hold positive charges over an extended time period. Consequently the positive charges can be swiftly handed over to the later-described carrier when the external additive having the positive charges comes into contact with the carrier, with the result that the toner can maintain a high-rate charge rising property.

The volume resistivity of the external additive can be adjusted by changing a kind or treatment amount of the surface treatment agent to be used. Examples of the hydrophobizing surface treatment agent include a silane coupling agent, a titanium coupling agent, and silicone oil. Among these agents, hexamethyldisilazane is preferably used which is a silane coupling agent excellent in a hydrophobic property and highly effective in preventing the toner from having charges fluctuating in amount. The external additive is preferably mixed in such a ratio that an amount of the external additive to be added is 0.5 part by weight or more and 5 parts by weight or less based on 100 parts by weight of the coloring resin particles. When too small an amount of the external additive is added, the effects of the external additive can be hardly attained. In contrast, when too large an amount of the external additive is added, the toner will have a decreased fixing property.

Furthermore, surface coverage of the coloring resin particles with the external additive is adjusted to 25% or more and 50% or less. Since the surface coverage is adjusted to 25% or more, the external additive sufficiently coats the surfaces of the coloring resin particles so that the toner can be provided with sufficient fluidity and sufficiently prevented from having its charges decreasing. And since the surface coverage is adjusted to 50% or less, the amount of the external additive being attached to the surfaces of the coloring resin particles is prevented from increasing too much so that the external additive can be prevented from interfering each other. Accordingly, the external additive externally added to the surfaces of the coloring resin particles can freely roll over on the surfaces of the coloring resin particles so that the toner can be provided with sufficient fluidity and moreover, positive charges can be swiftly handed over to the carrier when the external additive having the positive charges come into sufficient contact with the carrier, allowing the toner to maintain the high-rate charge rising property. It is therefore possible to prevent fog from appearing in an image obtained.

Note that the surface coverage of the coloring resin articles with the external additive can be derived from the following expression (3):

Cg=Sg÷St×100 (3)

(wherein Cg represents surface coverage (%), Sg represents total projection area (m²/g) of an external additive to be attached to surfaces of coloring resin particles, on the coloring resin particles per unit weight, and St represents a total surface area (m²/g) of coloring resin particles per unit weight.)

That is to say, the surface coverage car be determined by the following expression (4):

Cg=150×Wg÷(Bt×Dg×Rg) (4)

(wherein Cg represents surface coverage (%), Wg represents an amount (parts by weight) of external additive added per 100 parts by weight of coloring resin particles, Bt represents BET specific surface area (m²/g) per 1 g of coloring resin particles, Dg represents a primary particle size (nm) of an external additive, and Rg represents specific gravity (g/cm²) of an external additive.)

The external additive can be externally added to the coloring resin particles by using an airflow mixer such as HENSCHELMIXER. Note that the primary particle size of the external additive was determined based on a number average measured by using a scanning electronic microscope.

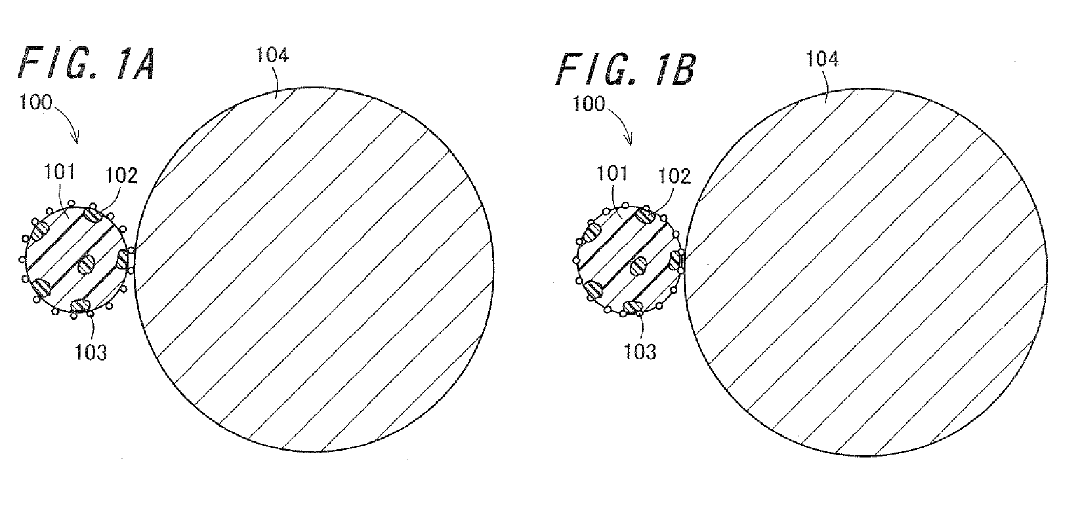

The two-component developer of the invention contains the above toner and the carrier. FIGS. 1A and 1B are sectional views each showing constitution of the toner 100 and a carrier 104 according to one embodiment of the invention. In the above toner 100 of the invention, an external additive 103 having the primary particle size and the volume resistivity adjusted to fall within predetermined ranges is externally added to surfaces of coloring resin particles 101 containing a boron compound 102 as shown in FIG. 1A. The external additive 103 is prevented from being completely buried in the coloring resin particles 101 as shown in FIG. 1B even in the case where image of low coverage are continuously printed or where the image forming apparatus has not operated for a long time and therefore, that the boron compound 102 contained in the coloring resin particles 101 is prevented from directly contacting the carrier 104 so that the negative charges held by the boron compound 102 can be prevented from leaking to the carrier 104. Consequently, even in the case where images of low coverage are continuously printed or where the image forming apparatus has not operated for a long time, the toner 100 can be prevented from having charges extremely decreasing and from causing fog, a decrease in image density, or the like trouble.

[Carrier]

The carrier is a magnetic material. As to saturated magnetization, magnetic brush in contact with the photoreceptor is softer with lower saturated magnetization. When the magnetic brush is soft, images can be authentically reproduced from electrostatic latent images. However, too low saturated magnetization may cause the carrier to be attached to the surface of the photoreceptor and thus easily generate white spots in an image obtained, while too high saturated magnetization results in rigid magnetic brush that impedes authentic image reproduction of electrostatic latent images. As a result, the saturated magnetization of the carrier is preferably adjusted to fall in a range of 30 emu/g or more and 100 emu/g or less.

Further, the carrier of the invention is adjusted to have a volume resistivity of 1×10⁹ Ω·cm or more and 2×10¹¹ Ω·cm or less. The volume resistivity of the carrier can be adjusted, for example, depending on the later-described core particles serving as a base for constitution of a carrier. Moreover, the above adjustment can also be carried out by changing a kind or amount of a conductive agent to be added to the coating layer of the carrier, which will be hereinafter described in detail.

By adjusting the volume resistivity of the carrier to 1×10⁹ Ω·cm or more as above, charges on the photoreceptor can be prevented from leaking to the carrier in developing the electrostatic latent image carried by the photoreceptor, and an image thus obtained can be prevented from having brush lines. Moreover, by adjusting the volume resistivity of the carrier to 2×10¹¹ Ω·cm or less, the toner can be prevented from having a charge amount extremely rising through contact with the carrier, so that an image obtained can be prevented from having reduced image density.

Note that the volume resistivity of the carrier was measured by the bridge method adopting the following procedure. Firstly, a 6.5 mm gap between two copper plate electrodes each having 30 mm width and 10 mm height was filled with 0.2 g of the carrier under environment having a temperature of 20° C. and humidity of 65%. Next, the carrier formed a bridge with magnetic lines of two magnets (100 mT) which are disposed outside the respective copper plate electrodes so that an N pole and an S pole face each other. In such a state, 500 V of voltage was applied and the voltage resistivity was measured when fifteen seconds passed after the application of voltage. The voltage resistivity of the carrier was thus determined.

Further, the carrier of the invention preferably has a volume average particle size of 30 μm or more and 100 μm or less. A carrier having too small a volume average particle size moves less easily from the developing roller to the photoreceptor, with the result that white spots appear in an image obtained. A carrier having too large a volume average particle size has poor dot reproducibility, thus forming a coarse image. Note that the volume average particle size of the carrier was measured on the condition of 3.0 bar dispersive pressure by using a dry-type dispersing device: RODOS (manufactured by Sympatec, Inc.) in a laser diffraction particle size analyzer: HELOS (manufactured by Sympatec, Inc.).

The carrier of the invention is composed of a magnetic core particle and a coating layer with which the core particle is coated.

(Core Particles)

For the core particles, the known magnetic particles can be used and in terms of chargeability and durability, ferrite particles are preferred. Usable examples of the ferrite particles include known substances such as zinc ferrite, nickel ferrite, copper ferrite, nickel-zinc ferrite, manganese-magnesium ferrite, copper-magnesium ferrite, manganese-zinc ferrite, and manganese-copper-zinc ferrite. These ferrite particles can be manufactured by the known method. For example, ferrite raw materials such as ferric oxide (Fe₂O₃) and magnesium hydroxide (Mg(OH)₂) are firstly mixed and then, mixed powder thus obtained is heated in a heating furnace to be tentatively fired. Next, the tentatively fired material thus obtained is cooled down and then pulverized by a vibrating mill into particles in the order of 1 μm. To pulverized powder thus obtained, a dispersant and water are added, resulting in a slurry. Subsequently, the slurry obtained is wet-pulverized by a wet ball mill, and suspension thus obtained is granulated and dried by a spray drier. The ferrite particles can be thus manufactured. In addition, the volume resistivity of the ferrite particles is preferably 1×10⁸ Ω·cm or more and 5×10¹⁰ Ω·cm or less. A carrier having ferrite particles of which the volume resistivity has been adjusted to fall within the above range serves as a carrier excellent in an electrical insulating property and an ability of removing counter charges remaining on a surface of the carrier. It is therefore possible to prevent fog, an edge effect on peripheries of solid image, and a decrease in image density.

(Coating Layer)

For a material constituting the coating layer, the known resin material can be used including, for example, acrylic resin and silicone resin. Among the resin, silicone resin is preferred. This is because the boron compound is less easily attached to a surface of a carrier having a coating layer made of silicone resin, so that the toner can maintain its ability of providing charges over a long period of time.

For silicone resin, the known ingredients can be used including, for example: silicone varnish such as TSR115, TSR114, TSR102, TSR103, YR3061, TSR110, TSR116, TSR117, TSR108, TSR109, TSR180, TSR181, TSR187, TSR144, and TSR165, all of which are trade names and manufactured by Shin-Etsu Chemical Co., Ltd., and KR271, KR272, KR275, KR280, KR282, KR267, KR269, KR211, and KR212, all of which are trade names and manufactured by TOSHIBA Corporation.; alkyd-modified silicone varnish such as TSR184 and TSR185, both of which are trade names and manufactured by TOSHIBA Corporation.; epoxy-modified silicone varnish such as TSR194 and YS54, both of which are trade names and manufactured by TOSHIBA Corporation.; polyester-modified silicone varnish such as TSR 187 (trade name) manufactured by TOSHIBA Corporation.; acryl-modified silicone varnish such as TSR170 and TSR171, both of which are trade names and manufactured by TOSHIBA Corporation.; urethane-modified silicone varnish such as TSR175 manufactured by TOSHIBA Corporation.; and reactive silicone resin such as KA1008, KBE1003, KHC1003, KBM303, KHB403, KBM503, KBM602, and KBM603, all of which are trade names and manufactured by Shin-Etsu Chemical Co., Ltd.

To the coating layer, a conductive agent is added for adjusting the volume resistivity of the carrier. Examples of the conductive agent include silicon oxide, alumina, carbon black, graphite, zinc oxide, titanium black, iron oxide, titanium oxide, tin oxide, potassium titanate, calcium titanate, aluminum borate, magnesium oxide, barium sulfate, and calcium carbonate. Among these substances, carbon black is preferred in terms of production stability, low cost, low electric resistance, etc. A kind of carbon black is not particularly limited, and carbon black having DBP (dibutyl phthalate) oil absorption of 90 ml/100 g or more and 170 ml/100 g or less is preferred owing to its excellent production stability. Moreover, carbon black having a primary particle size of 50 nm or less is particularly preferred owing to its excellent dispersibility. The conductive agent may be used each alone, or two or more of the conductive agents may be used in combination. An amount of the conductive agent to be added to the coating layer is 0.1 part by weight to 20 parts by weight or less based on 100 parts by weight of the resin material constituting the coating layer.

For a method of forming the coating layer on the core particle, the known method can be adopted. For example, the resin material and conductive agent for constituting the coating layer are firstly dissolved in an organic solvent to prepare a coating resin solution. Next, the coating resin solution is used to form the coating layer on the surface of the core particle. Examples of a method for forming the coating layer include: the dipping method that the core particles are dipped into the coating resin solution; the spray method that the coating resin solution is sprayed to the core particles; the fluid bed method that the coating resin solution is sprayed to the core particles floating in air flow; and the kneader coater method that the core particles and the coating resin solution are mixed with each other in a kneader coater. A specific method will be hereinbelow explained of forming the coating layer on the surface of the core particle by the dipping method. In the following explanation, ferrite particles are used as the core particles, and thermosetting silicone resin is used as the resin material constituting the coating layer. Firstly, the coating resin solution prepared by dissolving the thermosetting silicone resin in toluene, and the ferrite particles are put in a container of an agitator in a predetermined proportion and then agitated for a predetermined length of time. At this time, a coating film is formed on the surface of the ferrite particle. Next, the ferrite particles having the coating films formed thereon are put in a fixed heater to be heated at around 240° C. At this time, the silicone resin is thermally hardened and thus forms the coating layer on the surface of the ferrite particle.

A thickness of the coating layer is preferably adjusted to 0.5 μm or more and 5 μm or less. When a coating layer is too thin, the charges on the surface of the photoreceptor move to the carrier, resulting in brush lines appearing in an image obtained. In contrast, when a coating layer is too thick, counter charges remaining in the carrier after the toner development cannot be swiftly eliminated, thus resulting in an image with edges. Note that the thickness of the coating layer can be measured by observing a thin piece of thinly sliced carrier with a transmission electron microscope while the thickness of the coating layer can alternatively be determined based on particle-size specific gravity of the core particles and application quantity and specific gravity of the coating resin solution in forming the coating layer.

The two-component developer of the invention can be manufactured by mixing the above toner and carrier in a mixer such as a Nauta mixer. The toner and the carrier are mixed in the proportion of 3 parts by weight or more and 15 parts by weight or less of the toner to 100 parts by weight of the carrier.

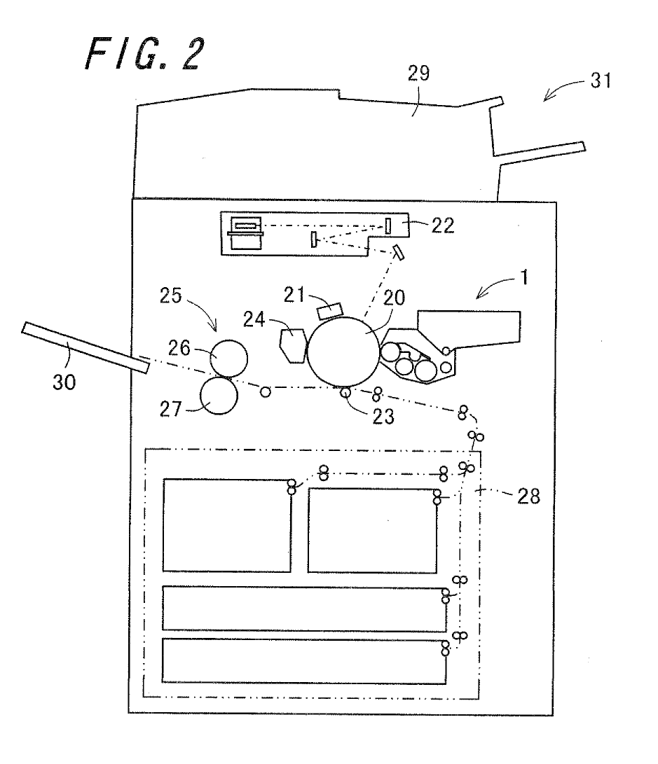

FIG. 2 is a view showing a configuration of an image forming apparatus 31 according to one embodiment of the invention. The image forming apparatus 31 is a digital copier on which a copy mode and a print mode are selectively available. In the copy mode, a copy of a document can be printed according to image information of the document read by a later-described scanner unit 29. In the print mode, a corresponding image can be printed in accordance with image information transmitted from an external device connected to the image forming apparatus 31 via a network.

In the image forming apparatus 31, the above-described two-component developer is used as a developer for forming images. In the image forming apparatus 31, since images are formed by use of the two-component developer having the toner with charges prevented from leaking to the carrier, the toner can be prevented from having charges extremely decreasing and from causing fog, a decrease in image density, or the like troubles even in the case where images of low coverage are continuously printed or where a printing operation restarts immediately after long suspension of operation in the image forming apparatus 31.

The image forming apparatus 31 includes a photoreceptor 20, a charging section 21, an exposure section 22, a developing section 1, a transferring section 23, a fixing section 25, a cleaning section 24, a paper feed tray 28, a scanner unit 29, and a catch tray 30.

The photoreceptor 20 is a roller-shaped member rotatably supported around an axis thereof by a driving section (not shown) and provided with a photosensitive layer on whose surface an electrostatic latent image and thus a toner image are to be formed. For the photoreceptor 20, a roller-shaped member is usable, for example, including a conductive substrate (not shown) and a photosensitive layer (not shown) formed on a surface of the conductive substrate. A usable conductive substrate includes cylindrical, columnar, and sheet-shaped conductive substrates, among which the cylindrical conducive base is preferred. The photosensitive layer includes an organic photosensitive layer and an inorganic photosensitive layer. Examples of the organic photosensitive layer include a layered photoreceptor composed of a charge generating layer as a resin layer containing a charge generating substance and a charge transporting layer as a resin layer containing a charge transporting substance, and a single-layer type photoreceptor having one resin layer containing a charge generating substance and a charge transporting substance. Examples of the inorganic photosensitive layer include a film containing one or two or more substances selected from zinc oxide, selenium, and amorphous silicon. An undercoat layer may be interposed between the conductive substrate and the photosensitive layer, and a surface of the photosensitive layer may be provided with a surface layer (protective layer) for mainly protecting the photosensitive layer.

The charging section 21 is, for example, a saw-tooth type charger for corona-discharging to the photoreceptor 20. To the charging section 21, a power source (not shown) is connected for applying voltage to the charge section 21. Upon the power source applying the voltage to the charging section 21, the charging section 21 generates the corona discharge so that the surface of the photoreceptor is charged at predetermined polarity and potential. The charging section 21 is not limited to the above charger, and other charger are usable such as a charging brush type charger, a roller-shaped charger, an ion-generating device, and a magnetic brush.

The exposure section 22 is, for example, a laser scanning device containing a light source. The laser scanning device incorporates the light source, a polygon mirror, a fθ lens, a reflecting mirror, and the like element. Usable examples of the light source include a semiconductor laser element, an LED array element, and an electroluminescence (EL) element. To the exposure section 22, image information of a document read by the later-described scanner unit 29 or image information transmitted from an external device are inputted. In the exposure section 22, the charged surface of the photoreceptor 20 is irradiated with laser light according to the image information. On the surface of the photoreceptor 20, the electrostatic latent image according to the image information is thus formed.

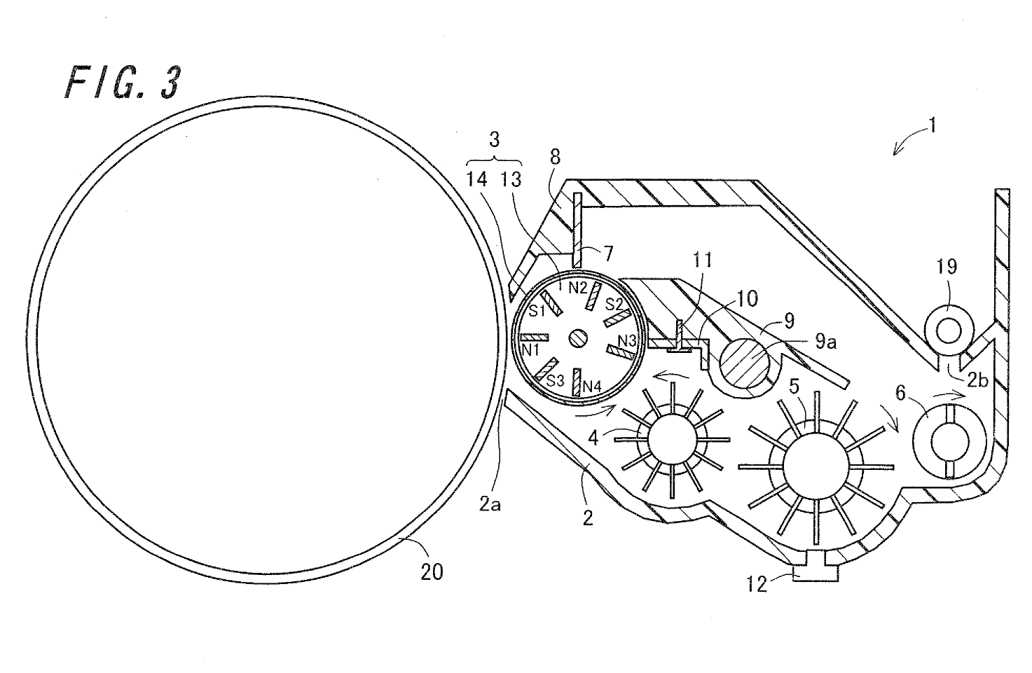

In the developing section 1, the two-component developer of the invention is supplied to the electrostatic latent image carried by the photoreceptor 20 so that a visualized image is formed. FIG. 3 is a sectional view showing a configuration of the developing section 1. The developing section 1 includes a developer tank 2, a developing roller 3, a first agitating member 4, a second agitating member 5, a conveying member 6, a regulating member 7, a regulating member support 8, a flow plate 9, a magnetic member 10, a magnetic member support 11, and a toner density detecting sensor 12. The developer tank 2 is a substantially prismatic container member having an internal space where the two-component developer of the invention is contained. The developer tank 2 rotatably supports the developing roller 3, the first agitating member 4, the second agitating member 5, and the conveying member 6, and directly and indirectly supports the regulating member 7, the flow plate 9, etc. Further, the developer tank 2 has an opening 2a in a side wall facing the photoreceptor 20, through which opening 2a the developer is supplied toward the electrostatic latent image formed on the surface of the photoreceptor 20. Moreover, an upper surface of the developer tank 2 has a toner supply port 2b that is an opening through which the toner is supplied.

Vertically above the developer tank 2, a toner cartridge (not shown) and a toner hopper (not shown) are disposed. In more detail, the toner cartridge, the toner hopper, and the developer tank 2 are arranged in this order vertically downward. The toner cartridge contains the toner in its internal space and is detachable from a wall surface of the image forming apparatus 31. The toner contained in the toner cartridge drops down to the toner hopper from the opening formed in the toner cartridge as the toner cartridge rotates around on its own axis when driven by a driving section (not shown). The toner is thus supplied to the toner hopper. In the toner hopper, a toner discharge port is provided so as to vertically communicate with the toner supply port 2b formed in the developer tank 2. The toner discharge port is an opening through which the toner is discharged from the toner hopper toward the developer tank 2. Furthermore, in the toner hopper, a toner supply roller 19 is provided vertically above the toner discharge port. The toner supply roller 19 is rotatably supported by the toner hopper and driven to rotate by a driving section (not shown). The rotation of the toner supply roller 19 is controlled by a control unit (not shown) disposed in the image forming apparatus in accordance with a detection result of the toner density detecting sensor 12 regarding density of the toner contained in the developer tank 2. The rotation of the toner supply roller 19 causes the toner to be supplied from the toner hopper into the developer tank 2 through the toner supply port 2b.

The developing roller 3 is a roller-shaped member which is at least partially supported by the developer tank 2 so as to be rotatable and which is driven to rotate around on its own axis by a driving section (not shown). The developing roller 3 is arranged so as to face the photoreceptor 20 across the opening 2a of the developer tank 2. The developing roller 3 is spaced away from the photoreceptor 20 so as to form a gap therebetween. The narrowest part of the gap is called a development nip portion. In the development nip portion, the toner is supplied from a developer layer (not shown) on a surface of the developing roller 3 to the electrostatic latent image on the surface of the photoreceptor 20. In the development nip portion, development bias voltage is applied to the developing roller 3 from a power source (not shown) connected to the developing roller 3, with the result that the toner smoothly moves from the developer layer on the surface of the developing roller 3 to the electrostatic latent image on the surface of the photoreceptor 20. The developing roller 3 contains a magnet roller 13 and a sleeve 14. The magnet roller 13 has longitudinally opposite ends supported by walls of the developer tank 2. The magnet roller 13 is a multi-pole magnetized magnet roller formed of a plurality of bar magnets, i.e., magnetic poles N1, N2, N3, and N4 and magnetic poles S1, S2 and S3 each having a rectangular cross section as viewed along a circumference of the developing roller 3 and being radially arranged and spaced away from each other in the developing roller 3. The respective magnetic poles are arranged in the order as follows: the magnetic poles N1, S1, N2, S2, N3, N4, and S3, in a direction reverse to a direction of rotation of the developing roller 3 (the sleeve 14).

In the magnet roller 13, the magnetic pole N3 is preferably disposed in a specific angular range on an upstream side of the magnetic pole S2 in the direction of rotation of the developing roller 3 (which upstream side will be hereinafter referred to simply as “upstream side” otherwise particularly specified. An angle of the angular range indicates an angle formed by a radius of the developing roller 3 on its cross section where the magnetic pole S2 is located (which radius will be hereinafter referred to as “radius S2”), and a radius of the developing roller 3 on its cross section where the magnetic pole N3 is located (which radius will be hereinafter referred to as “radius N3”). The angular range is preferably 33° or larger, and smaller than an angle formed by the radius S2 and a straight line connecting a shaft center of the developing roller 3 with a shaft center of the later-described first agitating member 4 (which angle will be hereinafter referred to “installation angle of the first agitating member 4”) With an angular range smaller than 33°, image defects such as uneven image density will easily appear. With an angular range larger than the installation angle of the first agitating member 4, an extended line of the radius N3 will extend vertically below the shaft center of the first agitating member 4. As a result, the first agitating member 4 exhibits lower ability to lift the developer toward the developing roller 3 and accordingly, image defects such as a decrease or unevenness in image density are caused more easily.

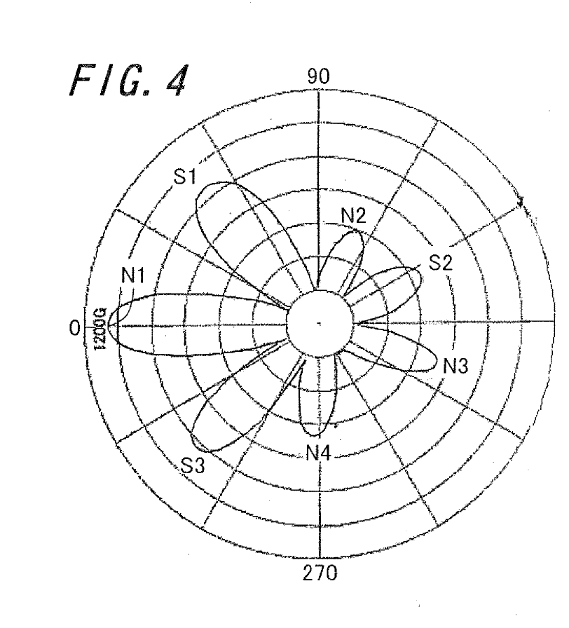

Further, in the present embodiment, the respective magnetic poles are arranged in the magnet roller 13 as follows. FIG. 4 is a view showing a magnetic intensity distribution of respective poles of the magnet roller 13 provided in the developing roller 3. The magnetic pole N1 (having a peak value of 105.8 mT) is positioned opposite to the photoreceotor 20 and disposed on a straight line connecting the shaft center of the developing roller 3 with a shaft center of the photoreceptor 20. The magnetic pole S1 (having a peak value of −87.0 mT) is positioned 50.55° upstream of the magnetic pole N1. This angle indicates an angle formed by a radius S1 of the developing roller 3 on its section where the magnetic pole S1 is located, and a radius N1 of the developing roller 3 on its section where the magnetic pole N1 is located. The other angles are also defined as above. The magnetic pole N2 (having a peak value of 39.3 mT) is positioned 111.33° upstream of the magnetic pole N1. The magnetic pole N2 (having a peak value of −46.9 mT) is positioned 153.73° upstream of the magnetic pole N1. The magnetic pole N3 (having a peak value of 52.8 mT) is positioned 199.40 g upstream of the magnetic pole N1 and 45.67° upstream of the magnetic pole S2. The magnetic pole N4 (having a peak value of 46.8 mT) is positioned 272.40° upstream of the magnetic pole N1. The magnetic pole S3 (having a peak value of −83.2 mT) is positioned 314.80° upstream of the magnetic pole N1.

The sleeve 14 is a cylindrical member which is externally fitted onto the magnet roller 13 and rotatably supported by the developer tank 2 and a support member (not shown) so as to be rotatable when driven by a driving section (not shown). The sleeve 14 is formed of a non-magnetic material. In the embodiment, the sleeve 14 rotates counterclockwise while the photoreceptor 20 rotates clockwise. Accordingly, the sleeve 14 and the photoreceptor 20 rotate in opposite directions in the development nip portion.

The first agitating member 4 and the second agitating member 5 are both roller-shaped members, each of which is rotatably supported by the developer tank 2 and capable of rotating around on its own axis when driven by a driving section (not shown). In the embodiment, the first agitating member 4 rotates counterclockwise while the second agitating member 5 rotates clockwise. The first agitating member 4 faces the photoreceptor 20 across the developing roller 3 and is positioned vertically below the developing roller 3. In the embodiment, an angle formed by the radius S2 and the straight line connecting the shaft center of the developing roller 3 with the shaft center of the first agitating member 4, i.e., the installation angle of the first agitating member 4 is 54°. The second agitating member 5 faces the developing roller 3 across the first agitating member 4 and is positioned vertically below the developing roller 3. The first agitating member 4 and the second agitating member 5 agitate the developer stored inside the developer tank 2 so that the toner is uniformly charged, and lift the charged developer toward surroundings of the developing roller 3.

The conveying member 6 is a roller-shaped member which is rotatably supported by the developer tank 2 and capable of rotating when driven by a driving section (not shown). The conveying member 6 faces the first agitating member 4 across the second agitating member 5 and is disposed vertically below the toner supply port 2b. The toner supplied into the developer tank 2 through the toner supply port 2b is conveyed by the conveying member 6 to surroundings of the second agitating member 5.

The regulating member 7 is a plate-shaped member extending parallel to an axial direction of the developing roller 3, and has one lateral end supported by the developer tank 2 and the regulating member support 8 vertically above the developing roller 3 with the other lateral end spaced away from the surface of the developing roller 3 so that a gap is formed therebetween. In the embodiments, the regulating member 7 is disposed in a direction of radius of the developing roller 3 (on an extended line of radius of the developing roller 3) so that the extended line and the radius N1 of the developing roller 3 on its cross section where the magnetic pole N1 is located, form an angle of 90°. The regulating member 7 is formed of an elastic and non-magnetic metal such as stainless steel or aluminum, or synthetic resin. In the embodiment, a thin plate of stainless steel is used as the regulating member 7. The regulating member support 3 supports the regulating member 7 together with the developer tank 2. To be specific, the regulating member 7 is supported with its one lateral end and surrounding parts thereof sandwiched between the regulating member support 8 and the developer tank 2. The regulating member support 8 is formed of a material such as synthetic resin or metal, for example. In the embodiment, the regulating member support 8 is formed of synthetic resin. The regulating member 7 removes an excess developer from the developer layer borne on the surface of the developing roller 3 and thus regulates the developer layer so as to be uniform in thickness, thereby adjusting an amount of the developer to be conveyed. Further, the other lateral end and the developer layer slide and thus cause friction therebetween, by which charges are given to an insufficiently charged developer contained in the developer layer so that the developer contained in the developer layer is sufficiently charged.

The flow plate 9 is a plate-shaped member which is disposed upstream of the regulating member 7 in the direction of rotation of the developing roller 3 and located vertically above the first agitating member 4 and the second agitating member 5. The flow plate 9 has one lateral end facing the surface of the developing roller 3 with a gap therebetween, and the other lateral end extending away from the developing roller 3. In the present embodiment, the flow plate 9 is disposed so that its upper surface on and around its developing roller 3-side lateral end is parallel to a horizontal direction while the rest of the upper surface is inclined vertically downward away from the developing roller 3. The flow plate 9 is supported by a support member 9a which is inserted into a through hole longitudinally penetrating the flow plate 9 in a vertically lower part thereof. The flow plate 9 allows for smooth flows of the developer inside the developer tank 2, which prevent the uneven toner charging, toner blocking, or the like trouble. In detail, the developer removed from the surface of the developing roller 3 by the regulating member 7 temporarily stays in a space above the developing roller 3, and when the amount of the developer increases, the developer starts to flow on the upper surface of the flow plate 9 away from the developing roller 3. The developer flows along the upper surface of the flow plate 9 and drops down toward the second agitating member 53 from the lateral end of flow plate 9 located away from the developer roller 3. The developer dropped is evenly mixed with the other developer and a newly supplied toner by the first agitating member 4 and the second agitating member 5, and then conveyed to the developing roller 3.

Note that dimensions of the first agitating member 4, the second agitating member 5, the conveying member 6, the regulating member 7, the flow plate 9, and the magnetic member 10 are appropriately determined from a suitable range in accordance with the dimension of the developing roller 3. The toner density detecting sensor 12 is, for example, mounted on a bottom surface of developer tank 2 located vertically below the second agitating member 5 so as to have a sensor face exposed inside of the developer tank 2. The toner density detecting sensor 12 is electrically connected to a control unit (not shown). In accordance with a detection result of the toner density detecting sensor 12, the control unit performs a control of driving the toner cartridge to rotate, thereby supplying the toner into the developer tank 2 through the toner hopper. That is to say, when determining that the detection result of the toner density detecting sensor 12 is lower than a toner density set value, the control unit sends a control signal to a driving section for driving the toner cartridge to rotate, with the result that the toner cartridge is driven to rotate. For the toner density detecting sensor 12, a commonly-used toner density detecting sensor can be used including, for example, a transmitted light detecting sensor, a reflection light detecting sensor, and a permeability detecting sensor, among which the permeability detecting sensor is preferred.

In the case where the permeability detecting sensor is used as the toner density detecting sensor 12, a power source (not shown) is connected to the toner density detecting sensor 12. The power source applies to the toner density detecting sensor 12 drive voltage for driving the toner density detecting sensor 12 and control voltage for outputting the detection result of the toner density to the control unit. The application of voltage from the power source to the toner density detecting sensor 12 is controlled by the control unit. The toner density detecting sensor 12 is a sensor having a system of outputting the detection result of the toner density in form of an output voltage value upon the application of the control voltage. Since sensitivity of such a toner density detecting sensor 12 is basically high around a median of the output voltage, control voltage causing output voltage around the median is applied to the toner density detecting sensor 12. The toner density detecting sensor 12 as just described, i.e., the permeability detecting sensor is commercially available including TS-L, TS-A and TS-K, all of which are trade names manufactured by TDK Corporation.

In the developing section 1, the developer contained in the developer tank 2 is conveyed to an area vertically above the first agitating member 4 by rotation of the first agitating member 4 and the second agitating member 51 and then lift up in the area by the magnetic member 10 to be supplied ho the surface of the developing roller 3. The developing roller 3 rotates with its surface bearing the developer layer whose thickness is then regulated by the regulating member 7 and of which developer is charged, thereafter supplying the toner in the development nip portion to the electrostatic latent image on the photoreceptor 20. A developing operation is thus carried our. After completion of the development, the developing roller 3 rotates further and is given the developer again. The developer removed from the surface of the developing roller 3 by the regulating member 7 flows along the upper surface of the flow plate 9 away from the developing roller 3, thereby returning to an area between the second agitating member 5 and the conveying member 6, in which area the developer is mixed again with the other developer and then conveyed toward the developing roller 3. Inside the developer tank 2, the developer circulates as above. Moreover, the conveying member 6 conveys to surroundings of the second agitating member 5 the toner supplied into the developer tank 2 in accordance with the detection result of the toner density detecting sensor 12.

The transferring section 23 transfers the toner image on the surface of the photoreceptor 20 onto the recording medium. The transferring section 23 is a roller-shaped member which is rotatably supported by a support member (not shown) so as to be rotatable when driven by a driving section (not shown) and which is disposed in pressure-contact with the photoreceptor 20. For the transferring section 23, a roller-shaped member is used, for example, which is composed of a metallic core bar having a size of 8 mm or more and 10 mm or less and a conductive elastic layer formed on a surface of the metallic core bar. Usable examples of the metal forming the metallic core bar include stainless steel and aluminum. The conductive electric layer may be formed by blending a rubber material such as ethylene-propylene rubber (EPDM), EPDM foam, or urethane foam with a conductive agent such as carbon black. To a pressure-contact area (transfer nip portion) between the photoreceptor 20 and the transferring section 23, the recording medium is fed sheet by sheet from the paper-feed tray 28 by way of pick-up rollers and registration rollers (not shown) in synchronization with conveyance of the toner image effected by the rotation of the photoreceptor 20. When the recording medium passes through the transfer nip portion, the toner image on the surface of the photoreceptor 2 is transferred onto the recording medium. A power source (not shown) is connected to the transferring section 23 and applies thereto voltage of polarity opposite to that of the charged toner constituting the toner image. This causes the toner image to be smoothly transferred onto the recording medium.

In the fixing section 25, the recording medium having the toner image transferred thereto passes through a fixing nip portion where the toner constituting the toner image is molten and pressed onto the recording medium so that the toner image is fixed to the recording medium. The fixing section 25 includes a fixing roller 26 and a pressure roller 27. The fixing roller 26 is a roller-shaped member which is rotatably supported by a support member (not shown) and disposed so as to be rotatable around on its own axis when driven by a driving section (not shown). Inside the fixing roller 26, a heating member (not shown) is provided for heating the toner constituting the unfixed toner image borne on the recording medium which is conveyed from the transfer nip portion so that the toner is molten and thus fixed onto the recording medium. For the fixing roller 26, a roller-shaped member is used, for example, containing a core bar and an elastic layer. The core bar is formed of a metal such as iron, stainless steel, or aluminum. The elastic layer is formed of an elastic material such as silicone rubber and fluoro-rubber. The heating member generates heat by voltage applied thereto from a power source (not shown). Usable examples of the heating member include a halogen lamp and an infrared lamp.

The pressure roller 27 is a roller-shaped member which is rotatably supported and disposed so as to come into pressure-contact with the fixing roller 26 by a pressurizing member (not shown). The pressure roller 27 rotates as driven by rotation of the fixing roller 26. A pressure-contact area between the fixing roller 26 and the pressure roller 27 is called a fixing nip portion. Upon the fixing roller 26 heating and thus fixing the toner image onto the recording medium, the pressure roller 27 presses the molten toner onto the recording medium to thereby promote the fixing of the toner image onto the recording medium. For the pressure roller 27, a roller-shaped member can be used of which configuration is the same as that of the fixing roller 26. Also inside the pressure roller 27, a heating member may be provided. For the heating member, a member can be used of the same kind as that of the heating member provided inside the fixing roller 26. The recording mediums having the toner images fixed thereto are discharged by a conveying section (not shown) to the later-described catch tray 30 and piled thereon.

The cleaning section 24 cleans the surface of the photoreceptor 20 from which the toner has been transferred. The cleaning section 24 includes a cleaning blade (not shown) and a toner reservoir (not shown). The cleaning blade is a plate-shaped member which longitudinally extends in parallel with the photoreceptor 20 and which is disposed so as to have one lateral end in contact with the photoreceptor 20. From the surface of the photoreceptor 20, the cleaning blade removes the toner, paper dust, etc. remaining on the surface of the photoreceptor 20 after the toner image has been transferred onto the recording medium. The toner reservoir is a container-shaped member having an internal space where the toner removed by the cleaning blade is temporarily stored.

The paper-feed tray 28 is a tray for storing the recording mediums such as plain paper, coated paper, color copy paper, and films for OHP. A plurality of the paper-feed trays 28 are provided so that the recording mediums different in size are stored in respective paper-feed trays 28. Size of the recording medium includes A3, A4, B5, and B4. Further, the recording mediums of the same size may be stored in a plurality of the paper-feed trays 28. The recording mediums are fed sheet by sheet by way of pick-up rollers conveying rollers, and registration rollers (not shown) in synchronization with the conveyance of the toner image formed on the surface of the photoreceptor 20 to the transfer nip portion.

In the scanner unit 29, a document reader (not shown) is provided as well as a document set tray (not shown), a reversing automatic document feeder (abbreviated as RADF) (not shown), etc. The reversing automatic document feeder conveys a document placed on the document set tray to a document placement table of the document reader. The document reader includes the document placement table, a document scanner, a reflection member, and a CCD (charge coupled device) line sensor. In the document reader, image information of the document placed on the document placement table is read for each set of plural lines, for example, for every ten lines. The document placement table is a plate-shaped glass member on which documents are placed having image information to be read.

The document scanner includes a light source (not shown) and a first reflecting mirror. The document scanner reciprocates at constant speed V in parallel with a vertically lower surface of the document placement table, and emits light to an image-formed surface of the document placed on the document placement table. Through the light irradiation, a reflection light image is obtained. A light source is a source of light which is emitted to the document placed on the document placement table. On the first reflecting mirror, a reflection light image is reflected toward the reflection member. The reflection member includes a second reflecting mirror, a third reflecting mirror, and an optical lens (none of which are shown), thereby forming on the CCD line sensor the reflection light image obtained by the document scanner. The reflection member reciprocates at V/2 speed by following the reciprocation of the document scanner. The second reflecting mirror and the third reflecting mirror reflect the reflection light image toward the optical lens. The optical lens forms the reflection light image on the CCD line sensor. The CCD line sensor includes a photoelectrical conversion circuit for photoelectrical conversion of the reflection light image formed by the optical lens into electric signals, and outputs the electric signals to an image processing portion in the control unit. The photoelectrical conversion circuit contains a photoelectric transducer for converting optical signals to electric signals in form of charges, such as a phototransistor, and a charge coupled device for outputting charges. In the image processing portion, image information inputted by the document reader or an external device such as a personal computer is converted into electric signals which are then outputted to the exposure section 22.

The image forming apparatus 31 may include a control unit for separately or integrally controlling operations of the developing section 1, the charging section 21, the exposure section 22, the transferring section 23, the cleaning section 24, and the fixing section 25, which are described above. The control unit includes a memory portion, a computing portion, and a control portion. To the memory portion are inputted, for example, results detected by various sensors such as the toner density detecting sensor 12, set values, image information, table data, and programs. For the memory portion, those customarily used in the relevant filed can be used including, for example, a read only memory (ROM), a random access memory (RAM), and a hard disc drive (HDD). The computing portion takes out the various data (such as print commands, detection results, and image information) inputted in the memory portion, and programs for performing various controls, thereby conducting various detections and/or determinations. The control portion carries out operational controls by sending control signals to relevant components in accordance with results determined by the computing portion. The control portion and the computing portion are each a processing circuit realized by, for example, a microcomputer or a microprocessor having a central processing unit (CPU).

### EXAMPLES

Hereinafter, the invention on will be explained in detail with reference to Examples and Comparative examples. Firstly, the two-component developer of Examples and Comparative examples was manufactured in the following method.

[Manufacture of Coloring Resin Particles]

Coloring resin particles of Examples and Comparative examples were prepared by using the following materials.

100 parts by weight of the binder resin (polyester resin having a glass transition temperature of 60° C. and a softening temperature of 130° C., obtained by polycondensation of monomers of bisphenol A propylene oxide, terephthalic acid, and trimellitic anhydride)

2 parts by weight of a boron compound of compound No. B1 (LR-147 manufactured by Japan Carlit Co., Ltd.)

5 parts by weight of carbon black (MA-100 manufactured by Mitsubishi Chemical Corporation)

2 parts by weight of polypropylene wax (Viscol 550P manufactured by Sanyo Chemical Industries, Ltd.)

The above materials were mixed for ten minutes in an airflow mixer (HENSCHELMIXER manufactured by Mitsui Mining Co., Ltd.) The mixture thus obtained was molten and kneaded by a kneading/dispersing processor: KNEADEX MOS140-800 manufactured by Mitsui Mining Co., Ltd., and the kneaded material thus obtained was cooled down and then coarsely pulverized by a cutting mill. The coarsely pulverized material thus obtained was finely pulverized in a finely pulverizing device: CGS manufactured by Mitsui Mining Co., Ltd., and classified by using a pneumatic classifier: TSP separator manufactured by Hosokawa Micron Corporation. Coloring resin particles (J1) were thus obtained having a volume average particle size of 6.5 μm and BET specific surface area of 1.8 m²/g.

And coloring resin particles (J2) were prepared having a volume average particle size of 6.5 μm and BET specific surface area of 1.8 m²/g in the same preparing method as that of the coloring resin particles (J1) except that a boron compound of compound No. B2 was used instead of the boron compound of compound No. B1. Further, coloring resin particles (J3) were prepared having a volume average particle size of 6.5 μm and BET specific surface area of 1.8 m²/g in the same preparing method as that of the coloring resin particles (J1) except that the boron compound of compound No. B1 was not used.

[Manufacture of External Additives]

Table 2 shows external additives used in Examples and Comparative examples. An external additive (G1) was prepared by treating surfaces of silica fine particles having a primary particle size of 12 nm (and BET specific surface area of about 140 m²/g) with hexamethyldisilazane. External additives G4, G7, G10, G11, and 12 different in primary particle size were prepared in the same preparing method as that of the external additive (G1) except that silica fine particles had different primary particle sizes. Further, external additives G2, G3, and G13 different in volume resistivity were prepared in the same preparing method as that of the external additive (G1) except that hexamethyldisilazane used for the treatment was different in amount. Further, external additives G5, G6, and G14 different in volume resistivity were prepared in the same preparing method as that of the external additive (G4) except that hexamethyldisilazane used for the treatment was different in amount. Furthermore, external additives G8, G9, and G15 different in volume resistivity were prepared in the same preparing method as that of the external additive (G7) except that hexamethyldisilazane used for the treatment was different in amount.

TABLE 2

| External additive | Primary particle | Volume resistivity |
|---|---|---|
| No. | size (nm) | (Ω · cm) |
| G1 | 20 | 7 × 10¹³ |
| G2 | 20 | 2 × 10¹³ |
| G3 | 20 | 1 × 10¹² |
| G4 | 30 | 2 × 10¹³ |
| G5 | 30 | 8 × 10¹² |
| G6 | 30 | 1 × 10¹² |
| G7 | 16 | 6 × 10¹³ |
| G8 | 16 | 3 × 10¹³ |
| G9 | 16 | 2 × 10¹² |
| G10 | 50 | 2 × 10¹³ |
| G11 | 12 | 3 × 10¹³ |
| G12 | 7 | 4 × 10¹³ |
| G13 | 20 | 1 × 10¹¹ |
| G14 | 30 | 8 × 10¹⁰ |
| G15 | 16 | 2 × 10¹¹ |

[Manufacture of Toners]

To 100 parts by weight of the coloring resin particles (J1 to J3), the external additives (G1 to G15) were added in the proportion stated in the following Table 3, which were then mixed for two minutes in an airflow mixer: Henschel mixer manufactured by Mitsui Mining Co., having agitating blade tip speed set at 15 m/sec. Toners (T1 to T30) were thus prepared in which the external additives had been added to surfaces of the coloring resin particles.

TABLE 3

External additive

| | Coloring resin | | Additive amount |
|---|---|---|---|
| Toner No. | particle No. | No. | (part by weight) |
| T1 | J1 | G1 | 2.0 |
| T2 | J1 | G2 | 2.0 |
| T3 | J1 | G3 | 2.0 |
| T4 | J1 | G1 | 2.6 |
| T5 | J1 | G1 | 1.3 |
| T6 | J1 | G4 | 3.0 |
| T7 | J1 | G5 | 3.0 |
| T8 | J1 | G6 | 3.0 |
| T9 | J1 | G7 | 1.6 |
| T10 | J1 | G8 | 1.6 |
| T11 | J1 | G9 | 1.6 |
| T12 | J2 | G1 | 2.0 |
| T13 | J2 | G2 | 2.0 |
| T14 | J2 | G3 | 2.0 |
| T15 | J2 | G4 | 3.0 |
| T16 | J2 | G5 | 3.0 |
| T17 | J2 | G6 | 3.0 |
| T18 | J2 | G7 | 1.6 |
| T19 | J2 | G8 | 1.6 |
| T20 | J2 | G9 | 1.6 |
| T21 | J3 | G1 | 2.0 |
| T22 | J1 | G1 | 3.7 |
| T23 | J1 | G1 | 0.8 |
| T24 | J1 | G10 | 5.0 |
| T25 | J1 | G10 | 3.3 |
| T26 | J1 | G11 | 1.2 |
| T27 | J1 | G12 | 0.7 |
| T28 | J1 | G13 | 2.0 |
| T29 | J1 | G14 | 3.0 |
| T30 | J1 | G15 | 1.6 |

[Manufacture of Carrier]

Carriers of Examples and Comparative examples were prepared in the following method. Ferrite materials were mixed in a ball mill and then tentatively fired in a rotary kiln at 900° C. Tentatively fired powder thus obtained was finely pulverized into particles having an average size of 2 μm or less in a wet pulverizer by using a steel ball as a pulverizing medium. Ferrite fine powder thus obtained was granulated by the spray dry method, and granulated materials were fired at 1300° C. After fired, the materials were crushed by using a crusher, resulting in core particles formed of ferrite component having a volume average particle size of about 50 μm and volume resistivity of 1×10⁹ Ω·cm. Next, a liquid for coating, that is, a liquid to be used for coating the core particles, was fabricated by dissolving and dispersing in toluene 100 parts of silicone resin: TSR115 (trade name) manufactured by Shin-Etsu Chemical Co., Ltd. and 3 parts by weight of carbon black (having a primary particle size of 25 nm and oil absorption of 150 ml/100 g). The liquid for coating was sprayed to the core particles by a spray coating device, and the core particles were thus coated. After complete evaporation removal of toluene, a carrier was obtained which was 50 μm in volume average particle size, 1 μm in thickness of silicone resin-made film, 2×10¹⁰ Ω·cm in volume resistivity, and 65 emu/g in saturation magnetization.

[Manufacture of Two-Component Developer]

Two-component developers of Examples 1 to 20 and Comparative examples 1 to 10 listed in Table 4 were prepared by mixing the toners (T1 to T30) and the above carrier. A mixing method for the two-component developer was as follows: 6 parts by weight of the toner and 94 parts by weight of the carrier were put in a Nauta mixer: VL-0 (trade name) manufactured by Hosokawa Micron Corporation, and agitated for 20 minutes to be thereby mixed. The two-component developers of Examples and Comparative examples were thus prepared.

Using the two-component developer thus prepared, continuous print test was carried out by the image forming apparatus 31. Conditions for development were set in the image forming apparatus 31 as follows: a circumferential speed of the photoreceptor 20 was set at 400 mm/sec; circumferential speed of the developing roller was set at 560 mm/sec; a gap between the photoreceptor 20 and the developing roller 3 was set at 0.42 my; a gap between the developing roller 3 and the regulating blade was set at 0.5 mm; surface potential and development bias of the photoreceptor 20 were set so that an amount of the toner attached to paper was 0.5 mg/cm² with the least amount of toner attached to a non-image area in a solid image (having 100% density). For test paper, A4-sized electrophotographic paper: Multi-receiver manufactured by Sharp Document System Corporation was used. The print test of text image was carried cut in which the coverage of printed image recorded on test paper was 3%. Table 4 shows evaluation results of charge amount, image density, and fog density obtained when the two-component developers of Examples and Comparative examples were used. Such evaluation was made as follows.

<Charge Amount>

The charge amount of the toner was measured by using a small-sized suction type charge measurement system: Model 210HS-2A manufactured by Trek Japan K.K.

<Image Density>

The image density was evaluated in a manner that image density of 3 cm-square solid image (100% density) printed was measured by a reflection densitometer: RD918 manufactured by Macbeth Co. The image density was evaluated based on the following criteria.

Good: the image density was 1.3 or more with fibers of test paper completely covered by the toner.

Slightly poor: the image density was 1.2 or more and less than 1.3.

Poor: the image density was less than 1.2 with fibers of test paper incompletely covered by the toner.

<Fog Density>

The fog density was evaluated based on density of non-image area (0% density) in the test paper printed by the image forming apparatus 31. The fog density was measured as follows. Firstly, whiteness of the test paper not yet printed was measured by a whiteness checker: Z-Σ90 Color Measuring System (trade name) manufactured by Nippon Denshoku Industries Co., Ltd. Next, whiteness of non-image area in the test paper printed was measured by the above whiteness checker. And a difference was determined between the whiteness of the test paper not yet printed and the whiteness of the non-image area in the test paper printed. The difference was defined as fog density. The fog density was evaluated based on the following criteria.

Good: the fog density was less than 0.6 and the fog was hardly visible to the naked eye.

Slightly poor: the fog density was 0.6 or more and less than 1.0.

Poor: the fog density was 1.0 or more and the fog was clearly visible to the naked eye.

As shown in Table 4, in the continuous print test using the two-component developers of Examples 1 to 20 according to the invention, the toner had stable charge amount and images having high density and no fog were obtained even in the case where images of 3% coverage (low coverage) were continuously printed on 1,000 sheets. In addition, even after 12 hour rest of the image forming apparatus following the continuous print operation, the toner had its charges decreased to a small degree, and images having high density and no fog were printed.

On the contrary, in the continuous 1,000 sheet print test of Comparative example 1 (using the developer having no boron compound-containing toner), there appeared toner blowout presumably caused by non-charged toner, resulting in a decrease in image density and generation of fog although the toner had its charges decreased to a small degree. Further, in the continuous print test using the toner of which coverage was too high or too low as represented by Comparative example 2 or 3, the toner had its charges decreased and there appeared fog upon the continuous 1,000 sheet printing or after 12 hour rest. Furthermore, using the toner having an external additive with a large primary particle size as represented by Comparative example 4 or 5, a fixing failure occurred and obtained image density was not sufficient. And using the toner having an external additive with a small volume resistivity as represented by Comparative example 8, 9, or 10, the toner had its charged decreased and there appeared fog after 12 hour rest of the image forming apparatus although the toner had its charge decreased to a small degree upon the continuous 1,000 sheet print.

TABLE 4

| | | Coloring resin | | | | | | | | |
|---|---|---|---|---|---|---|---|---|---|---|
| | | particle | | External additive | | | | Initial | | |
| | | | Boron | | Primary | Volume | | Charge | | |
| | Toner | | compound | | particle | resistivity | Surface | amount | Image | Fog |
| | No. | No. | No. | No. | size (nm) | (Ω · cm) | coverage | (μc/g) | density | density |
| Ex. 1 | T1 | J1 | B1 | G1 | 20 | 7 × 10¹³ | 38 | 26.1 | Good | Good |
| Ex. 2 | T2 | J1 | B1 | G2 | 20 | 2 × 10¹³ | 38 | 25.9 | Good | Good |
| Ex. 3 | T3 | J1 | B1 | G3 | 20 | 1 × 10¹² | 38 | 23.4 | Good | Good |
| Ex. 4 | T4 | J1 | B1 | G1 | 20 | 7 × 10¹³ | 50 | 27.7 | Good | Good |
| Ex. 5 | T5 | J1 | B1 | G1 | 20 | 7 × 10¹³ | 25 | 22 | Good | Good |
| Ex. 6 | T6 | J1 | B1 | G4 | 30 | 2 × 10¹³ | 38 | 21.8 | Good | Good |
| Ex. 7 | T7 | J1 | B1 | G5 | 30 | 8 × 10¹² | 38 | 20.5 | Good | Good |
| Ex. 8 | T8 | J1 | B1 | G6 | 30 | 1 × 10¹² | 38 | 19.8 | Good | Good |
| Ex. 9 | T9 | J1 | B1 | G7 | 16 | 6 × 10¹³ | 38 | 27.6 | Good | Good |
| Ex. 10 | T10 | J1 | B1 | G8 | 16 | 3 × 10¹³ | 38 | 26.9 | Good | Good |
| Ex. 11 | T11 | J1 | B1 | G9 | 16 | 2 × 10¹² | 38 | 24.8 | Good | Good |
| Ex. 12 | T12 | J2 | B2 | G1 | 20 | 7 × 10¹³ | 38 | 25.8 | Good | Good |
| Ex. 13 | T13 | J2 | B2 | G2 | 20 | 2 × 10¹³ | 38 | 25.3 | Good | Good |
| Ex. 14 | T14 | J2 | B2 | G3 | 20 | 1 × 10¹² | 38 | 23.5 | Good | Good |
| Ex. 15 | T15 | J2 | B2 | G4 | 30 | 2 × 10¹³ | 38 | 21.7 | Good | Good |
| Ex. 16 | T16 | J2 | B2 | G5 | 30 | 8 × 10¹² | 38 | 20.6 | Good | Good |
| Ex. 17 | T17 | J2 | B2 | G6 | 30 | 1 × 10¹² | 38 | 19.9 | Good | Good |
| Ex. 18 | T18 | J2 | B2 | G7 | 16 | 6 × 10¹³ | 38 | 26.2 | Good | Good |
| Ex. 19 | T19 | J2 | B2 | G8 | 16 | 3 × 10¹³ | 38 | 36.3 | Good | Good |
| Ex. 20 | T20 | J2 | B2 | G9 | 16 | 2 × 10¹² | 38 | 24.9 | Good | Good |
| Comp. | T21 | J3 | — | G1 | 20 | 7 × 10¹³ | 38 | 18.5 | Good | Good |
| Ex. 1 | | | | | | | | | | |
| Comp. | T22 | J1 | B1 | G1 | 20 | 7 × 10¹³ | 70 | 28.8 | Good | Good |
| Ex. 2 | | | | | | | | | | |
| Comp. | T23 | J1 | B1 | G1 | 20 | 7 × 10¹³ | 15 | 20.6 | Good | Good |
| Ex. 3 | | | | | | | | | | |
| Comp. | T24 | J1 | B1 | G10 | 50 | 2 × 10¹³ | 38 | 24.3 | Poor | Good |
| Ex. 4 | | | | | | | | | | |
| Comp. | T25 | J1 | B1 | G10 | 50 | 2 × 10¹³ | 25 | 20.8 | Poor | Good |
| Ex. 5 | | | | | | | | | | |
| Comp. | T26 | J1 | B1 | G11 | 12 | 3 × 10¹³ | 38 | 27.6 | Good | Good |
| Ex. 6 | | | | | | | | | | |
| Comp. | T27 | J1 | B1 | G12 | 7 | 4 × 10¹³ | 38 | 29 | Good | Good |
| Ex. 7 | | | | | | | | | | |
| Comp. | T28 | J1 | B1 | G13 | 20 | 1 × 10¹¹ | 38 | 25.5 | Good | Good |
| Ex. 8 | | | | | | | | | | |
| Comp. | T29 | J1 | B1 | G14 | 30 | 8 × 10¹⁰ | 38 | 23.4 | Good | Good |
| Ex. 9 | | | | | | | | | | |
| Comp. | T30 | J1 | B1 | G15 | 16 | 2 × 10¹¹ | 38 | 26.8 | Good | Good |
| Ex. 10 | | | | | | | | | | |

| | 1,000 | | | | | | |
|---|---|---|---|---|---|---|---|
| | sheets | | | After 12 hour rest | | | |
| | Charge | | | Charge | | | |
| | amount | Image | Fog | amount | Image | Fog | |
| | (μc/g) | density | density | (μc/g) | density | density | Remark |
| Ex. 1 | 27.2 | Good | Good | 23.9 | Good | Good | |
| Ex. 2 | 26.8 | Good | Good | 23.6 | Good | Good | |
| Ex. 3 | 22.4 | Good | Good | 18.7 | Good | Good | |
| Ex. 4 | 29.2 | Good | Good | 26 | Good | Good | |
| Ex. 5 | 20.8 | Good | Good | 17.4 | Good | Good | |
| Ex. 6 | 22.5 | Good | Good | 19.3 | Good | Good | |
| Ex. 7 | 21.3 | Good | Good | 18.2 | Good | Good | |
| Ex. 8 | 19.5 | Good | Good | 16.4 | Good | Good | |
| Ex. 9 | 24.3 | Good | Good | 20.9 | Good | Good | |
| Ex. 10 | 24.6 | Good | Good | 21.1 | Good | Good | |
| Ex. 11 | 22.9 | Good | Good | 19.6 | Good | Good | |
| Ex. 12 | 27 | Good | Good | 23.2 | Good | Good | |
| Ex. 13 | 26.1 | Good | Good | 22.6 | Good | Good | |
| Ex. 14 | 22.8 | Good | Good | 20.2 | Good | Good | |
| Ex. 15 | 22.3 | Good | Good | 20.3 | Good | Good | |
| Ex. 16 | 20.7 | Good | Good | 18.6 | Good | Good | |
| Ex. 17 | 20.5 | Good | Good | 18.8 | Good | Good | |
| Ex. 18 | 24.1 | Good | Good | 20.6 | Good | Good | |
| Ex. 19 | 23.9 | Good | Good | 20.3 | Good | Good | |
| Ex. 20 | 23.9 | Good | Good | 20.2 | Good | Good | |
| Comp. | 25.6 | Slightly | Poor | 24.3 | Slightly | Poor | Toner |
| Ex. 1 | | poor | | | poor | | blowout |
| Comp. | 22.5 | Good | Poor | 21.9 | Good | Poor | Fixing |
| Ex. 2 | | | | | | | failure/ |
| | | | | | | | Toner |
| | | | | | | | blowout |
| Comp. | 20.1 | Good | Good | 13.8 | Slightly | Poor | Toner |
| Ex. 3 | | | | | poor | | blowout |
| Comp. | 23.9 | Poor | Good | 23.1 | Poor | Good | Fixing |
| Ex. 4 | | | | | | | failure |
| Comp. | 19.2 | Poor | Good | 18.6 | Poor | Good | Fixing |
| Ex. 5 | | | | | | | failure |
| Comp. | 23.5 | Good | Good | 13.5 | Slightly | Poor | Toner |
| Ex. 6 | | | | | poor | | blowout |
| Comp. | 22.8 | Good | Good | 11.2 | Slightly | Poor | Toner |
| Ex. 7 | | | | | poor | | blowout |
| Comp. | 20.9 | Good | Good | 13.6 | Slightly | Poor | Toner |
| Ex. 8 | | | | | poor | | blowout |
| Comp. | 21.3 | Good | Good | 14.3 | Slightly | Poor | Toner |
| Ex. 9 | | | | | poor | | blowout |
| Comp. | 23 | Good | Good | 12.8 | Slightly | Poor | Toner |
| Ex. 10 | | | | | poor | | blowout |

The invention may be embodied in other specific norms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A toner comprising:
coloring resin particles formed of at least a boron compound, a binder resin and a colorant,
the boron compound being represented by the following general formula (1): 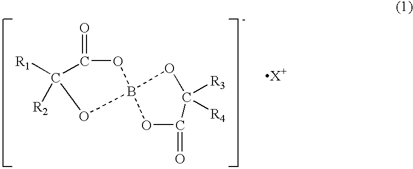
(where R₁ and R₄ each represents a hydrogen atom, an alkyl group, or a substituted or non-substituted aromatic ring (including a condensed ring) R₂ and R₃ each represents a substituted or non-substituted aromatic ring (including a condensed ring), and X⁺ represents a cation); and
an external additive externally added to surfaces of the coloring resin particles, the external additive being adjusted to have a primary particle size of 16 nm or more and 30 nm or less and a volume resistivity of 1×10¹² Ω·cm or more and 5×10¹⁵ Ω·cm, and
a surface coverage of the coloring resin particles with the external additive being 25% or more and 50% or less.

2. The toner of claim 1, wherein the external additive is formed of fine silica particles having a hydrophobized surface.

3. The toner of claim 1, wherein the coloring resin particles have a volume average particle size of 5 μm or more and 7 μm or less and BET specific surface area of 1.5 m²/g or more and 1.9 m²/g or less.

4. A two-component developer containing the toner of claim 1 and a magnetic carrier having a volume resistivity of 1×10⁹ Ω·cm or more and 2×10¹¹ Ω·cm or less.

5. The two-component developer of claim 4, wherein the carrier is composed of a core particle and a coating layer with which the core particle is coated and the coating layer has a thickness of 0.5 μm or more and 5 μm or less.

6. The two-component developer of claim 5, wherein the coating layer of the carrier contains a conductive agent, and the conductive agent is carbon black having an oil absorption of 90 ml/100 g or more and 170 ml/100 g or less.

7. An image forming apparatus comprising:
a photoreceptor for bearing an electrostatic latent image;
a charging section for charging a surface of the photoreceptor;
an exposure section for forming the electrostatic latent image on the surface of the photoreceptor;
a developing section for supplying a developer to the electrostatic latent image formed on the surface of the photoreceptor to form a visualized image;
a transferring section for transferring the visualized image to a recording medium;
a cleaning section for removing the developer remaining on the surface of the photoreceptor; and
a fixing section for fixing the visualized image transferred to the recording medium,
the developer being the two-component developer of claim 4.
